(19) United States
(12) Patent Application Publication
(10) Pub. No.: US 2026/0279134 A1
(43) Pub. Date: Sep. 17, 2026

(54) Multi-Item Food Vending Machinery & Methods

(71) Applicants: Adam Cohen, Dallas, TX (US); Charles Studor, Dallas, TX (US)

(72) Inventors: Adam Cohen, Dallas, TX (US); Charles Studor, Austin, TX (US)

(21) Appl. No.: 19/561,459

(22) Filed: Mar. 9, 2026

Related U.S. Application Data
(63) Continuation-in-part of application No. 18/166,463, filed on Feb. 8, 2023.
Application No. 18/166,463 is a continuation-in-part of application No. 16/870,088, filed on May 8, 2020, now Pat. No. 11,610,276.
Application No. 16/870,088 is a continuation-in-part of application No. 16/949,416, filed on Oct. 28, 2020, now abandoned.
Application No. 16/949,416 is a continuation-in-part of application No. 17/026,097, filed on Sep. 18, 2020, now Pat. No. 12,016,486.
(60) Provisional application No. 62/845,000, filed on May 8, 2019.
(60) Provisional application No. 63/267,717, filed on Feb. 8, 2022.
(60) Provisional application No. 63/769,124, filed on Mar. 9, 2025.

(51) Int. Cl. G07F 17/00; H05B 6/80

(52) U.S. Cl. CPC G07F 17/0064; H05B 6/808

(57) ABSTRACT

Food vending machinery and methods involving the dispensing of multiple items, most especially restaurant-quality meals which, to optimize quality and value to the consumer, comprise both hot and cold (or warm) components.

### CROSS REFERENCE TO RELATED APPLICATIONS

The table below sets forth the priority claims for the instant application along with filing dates and patent numbers as appropriate. Each of the listed applications and/or patents referenced herein is incorporated herein by reference as if set forth in full herein.

| | | | | | Related | Related |
|---|---|---|---|---|---|---|
| | | | Which was filed | Which is | application | application |
| Application | Continuity type | App. No. | (YYYY-MM-DD) | now | docket # | nickname |
| This application | claims benefit of | 63,769,124 | 2025 Mar. 9 | Pending | NC-P-25-1 | P12 |
| This application | is a CIP of | 18/166,463 | 2023 Feb. 8 | Pending | NC-NP-23-1 | NP4 |
| 18/166,463 | claims benefit of | 63/267,717 | 2022 Feb. 8 | Expired | NC-P-22-1 | P10 |
| 18/166,463 | is a CIP of | 16/870,088 | 2020 May 8 | Issued as | NC-NP-20-1 | NP3 |
| | | | | 11,610,276 | | |
| 18/166,463 | is a CIP of | 16/949,416 | 2020 Oct. 28 | Abandoned | IN-NP-20-2 | NP1-C0N |
| 18/166,463 | is a CIP of | 17/026,097 | 2020 Sep. 18 | Issued as | IN-NP-20-1 | NP2-C0N |
| | | | | 12,016,486 | | |
| 16/870,088 | claims benefit of | 62/845,000 | 2019 May 8 | Expired | NC-P-19-1 | P8 |
| 16/870,088 | is a CIP of | 16/182,563 | 2018 Nov. 6 | Abandoned | NP-18-1 | NP2 |
| 16/870,088 | is a CIP of | 15/805,074 | 2017 Nov. 6 | Abandoned | NP-17-1 | NP1 |
| 16/949,416 | is a continuation | 15/805,074 | 2017 Nov. 6 | Abandoned | NP-17-1 | NP1 |
| | of | | | | | |
| 17/026,097 | is a continuation | 16/182,563 | 2018 Nov. 6 | Abandoned | NP-18-1 | NP2 |
| | of | | | | | |
| 16/182,563 | is a CIP of | 15/805,074 | 2017 Nov. 6 | Abandoned | NP-17-1 | NP1 |
| 16/182,563 | claims benefit of | 62/588,913 | 2017 Nov. 20 | Expired | P-17-4 | P5 |
| 16/182,563 | is a CIP of | PCT/US17/60253 | 2017 Nov. 6 | Expired | PCT-17-1 | PCT1 |
| 16/182,563 | claims benefit of | 62/670,043 | 2018 May 11 | Expired | P-18-1 | PE |
| 16/182,563 | claims benefit of | 62/724,019 | 2018 Aug. 28 | Expired | P-18-2 | P7 |
| 15/805,074 | claims benefit of | 62/417,336 | 2016 Nov. 4 | Expired | P-16-1 | P1 |
| 15/805,074 | claims benefit of | 62/456,008 | 2017Feb. 7 | Expired | P-17-1 | P2 |
| 15/805,074 | claims benefit of | 62/471,957 | 2017 Mar. 15 | Expired | P-17-2 | P3 |
| 15/805,074 | claims benefit of | 62/522,671 | 2017 Jun. 20 | Expired | P-17-3 | P4 |

### FIELD OF THE INVENTION

This disclosure generally relates to the field of food vending.

### STATEMENT OF FEDERALLY FUNDED RESEARCH

Not applicable.

### SUMMARY

Food vending machines typically fall into one of several categories depending on the temperature at which the food is dispensed: 1) ambient temperature, 2) cold (refrigerated or frozen), or 3) hot (heated from a refrigerated or frozen state). However, restaurants—especially fast casual brands serving bowl-based meals (e.g., Chipotle, Sweetgreen, CAVA) or tacos—commonly serve meals that incorporate multiple ingredients served at different temperatures. Serving all of the ingredients of such a meal cold, hot, or lukewarm would greatly reduce the quality and enjoyment of the meal, potentially reduce its nutritional value, and in some cases damage some of the ingredients. Therefore there is a need for a food vending machine to provide not just nutritious, substantial meals (vs. just snacks), but also meals in which all ingredients are served at suitable temperatures.

Though somewhat extended hot-holding times are possible with specialized equipment and applicable to certain ingredients, the shelf life of most ingredients is generally greatest when the ingredients are refrigerated (or in some cases, frozen). Thus, in a vending application where food is loaded at one time and served hours or days later, shelf life is critical and refrigeration (or freezing, if suitable) of meals is highly advisable. To then serve meals with all ingredients at suitable temperatures requires that certain ingredients transition from a cold state to a warm or hot state. More generally, different ingredients may require different serving temperatures: some might be best unheated, some heated slightly, and some heated significantly. Current vending machines and their control software do not allow for such variable, selective, differentiated heating of ingredients.

It is an object of some embodiments of the invention to allow high quality, tasty, delicious food to be provided in locations and at times of day that would otherwise not be possible.

It is an object of some embodiments of the invention to provide higher quality food options to a consumer using an automated food vending system.

It is an object of some embodiments of the invention to differentially heat different ingredients so as to bring each of them to a suitable serving temperature.

Other objects and advantages of various embodiments of the invention will be apparent to those of skill in the art upon review of the teachings herein. The various embodiments of the invention, set forth explicitly herein or otherwise ascertained from the teachings herein, may address one or more of the above objects alone or in combination, or alternatively may address some other object ascertained from the teachings herein. It is not necessarily intended that all objects be addressed by any single aspect of the invention even though that may be the case with regard to some aspects.

In accordance with certain aspects of the invention, a method is provided for dispensing a meal from a self-service vending machine. The method includes receiving, via a user interface, a consumer selection of a first meal component, receiving a selection of a second meal component associated with the first meal component, receiving a single payment for a meal comprising the first meal component and the second meal component, and controlling the vending machine to dispense the first meal component and the second meal component in response to the single payment.

In certain aspects, the selection of the second meal component may be made directly by the consumer through the user interface. In other aspects, the selection of the second meal component may be automatically determined by a machine controller based on the consumer's selection of the first meal component.

In some aspects of the invention, the first and second meal components are dispensed at different temperature ranges. For example, one component may be dispensed at a relatively hot temperature suitable for cooked foods while the other component may be dispensed at a lower temperature suitable for toppings, sauces, or other complementary items.

In certain aspects, the vending machine may provide multiple options for the first meal component. In response to the consumer's selection of the first meal component, the machine controller may automatically select a predetermined second component without additional action by the consumer. In other aspects, the machine controller may present one or more predetermined options for the second component and require the consumer to select among those options. In still further aspects, the machine controller may present multiple predetermined options for the second component and may additionally provide a recommendation to the consumer.

In certain embodiments, the first and second meal components may be dispensed within a single container. In other embodiments, the components may be dispensed in separate containers.

In some aspects, one of the meal components may comprise a topping or complementary item associated with the other component.

In certain embodiments, at least one container is configured to hold the first and second components and to permit heating of one or more components through exposure to radio frequency (RF) energy. In some embodiments, RF energy emitted from a relatively small radiating aperture is applied to the container to heat the contents. In certain implementations, one of the meal components may be at least partially isolated from the RF energy through attenuation provided by an RF shield.

In some aspects, the RF shield may include materials such as a water-based gel, a microwave susceptor, or combinations of such materials optionally combined with an insulating structure. In certain embodiments, the RF shield may be separated from the meal component being protected from RF energy by a thermal insulator.

In some embodiments in which the meal components are dispensed in separate containers, the containers may be delivered to the consumer in a common delivery compartment or onto a shelf within the vending machine. In certain implementations, the vending machine may dispense a first container into the delivery compartment and subsequently dispense a second container such that the second container is stacked on top of the first container.

In certain aspects, both containers may be made accessible to the consumer at substantially the same time. In other aspects, the containers may be dispensed sequentially.

In some embodiments, dispensing of a second container may be temporarily prevented by an obstruction caused by the presence of the first container. In such cases, the vending machine controller may detect the obstruction condition, withhold dispensing of the second container while the obstruction persists, and dispense the second container after the obstruction condition has been cleared.

In certain implementations, the vending machine may provide notifications prompting the consumer to remove containers at different times. For example, the controller may notify the consumer to remove a first container at a first time and may notify the consumer to remove a second container at a later time.

In some aspects, the vending machine user interface may control availability of meal components. In certain implementations, the second component may not be selectable unless the first component has been selected. In other implementations, a particular first component may be rendered unavailable for ordering if an associated second component is not currently available.

In another aspect of the invention, a user interface is provided for a vending machine configured to dispense first and second meal components in response to a single transaction. The user interface may include a display device, a machine controller, graphical elements indicating available first meal components, graphical elements indicating available second meal components, and mechanisms enabling user selection of the first and second meal components.

In yet another aspect, a vending machine control method is provided in which the selection of a first item restricts the selection of a second item. In certain embodiments, selection of the second item may be restricted to a single available item. In other embodiments, selection of the second item may be restricted to a subset of available items.

The foregoing aspects are illustrative and not limiting. Various modifications, combinations, and variations of the aspects described above may be implemented without departing from the scope of the invention.

### BRIEF DESCRIPTION OF THE DRAWINGS

FIGS. 1-2 depict flowcharts describing process flows for a vending machine.

FIGS. 3A-3C depict containers having compartments for food at different temperatures.

FIGS. 4A-4D depict stacked pairs of containers arranged to be differentially heated.

FIGS. 5A-5B (sheet 9) depict single containers with food arranged to be differentially heated.

FIG. 6 depicts a stacked container similar to that of FIGS. 4A-4D but in an inverted arrangement.

FIGS. 7A-7H depict designs for shielding devices of various types.

FIGS. 8A-8D depict a clamshell container and approach to differential heating.

FIGS. 9A-9B depict an arrangement for differentially heating food components arranged side-by-side.

FIGS. 10A-10C depict flowcharts describing process flows for a vending machine.

FIGS. 11A-11B depict two screens in a user interface.

FIG. 12 depicts a flowchart describing a process flow for a vending machine.

FIG. 13 depicts a flowchart describing a time estimation process.

FIGS. 14A-14C are views showing a portion of a hot vending machine at different times.

FIG. 15 depicts a flowchart describing a process flow for a vending machine such as that of FIGS. 14A-14C.

FIGS. 16A-16H depict steps in a process flow for a vending machine dispensing two containers.

FIGS. 17A-17F depict steps in a process flow for a vending machine dispensing two containers.

### DETAILED DESCRIPTION OF THE EMBODIMENTS

Meals may be provided to a consumer in which all ingredients are in a single container. If such meals comprise ingredients that should be served at different temperatures, then differential heating of those ingredients can be achieved using machinery and methods described herein. Generally, ingredients would be physically grouped together as two or more ‘components’ (e.g., a ‘hot’ (i.e., to be heated) component and a cold component), facilitating selective heating of one component relative to another. In some cases, rather than have more than one component in a single container, each component can be within its own, separate container. This approach can have several advantages such as greater meal customization (e.g., allowing the consumer to select among multiple hot components and independently, multiple cold components), and can facilitate differential heating since a container holding a cold component might not require heating at all, or in any case less than a container holding a ‘hot’ component). From a user experience perspective, it is highly desirable to require that the consumer only make a single purchase transaction. In the case of a single container, the traditional behavior of a vending machine purchase may be appropriate. But in the case of two (or more) containers, that behavior is not applicable: one does not want to make two purchases to obtain both containers. Moreover, the ‘hot’ and cold components, each in their own container, are associated with one another (i.e., together they form a complete meal), so guidance in the ordering process and constraints must be provided to ensure the intended result (i.e., one generally wishes to avoid the consumer purchasing a partial meal with only one component, a ‘meal’ with two ‘hot’ but no cold components, etc.).

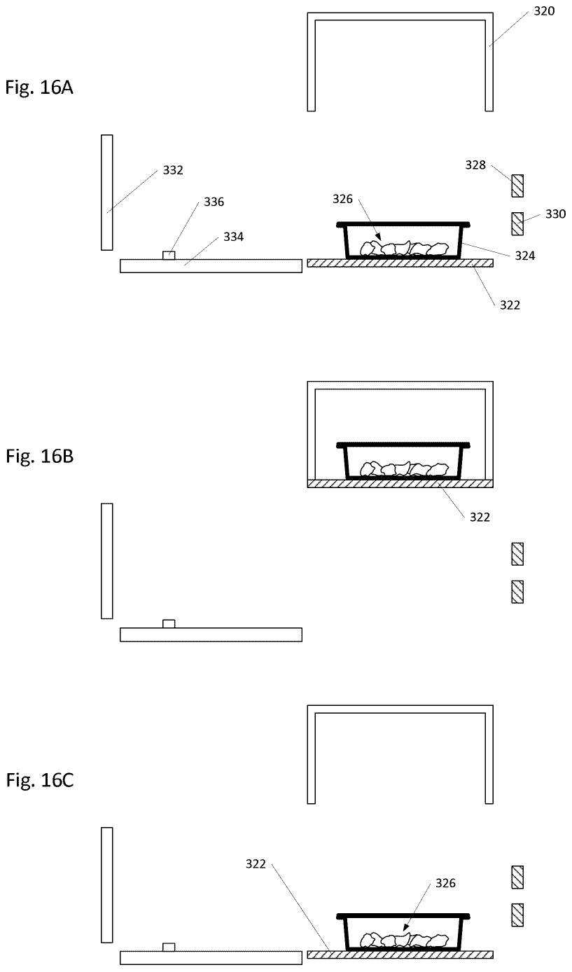

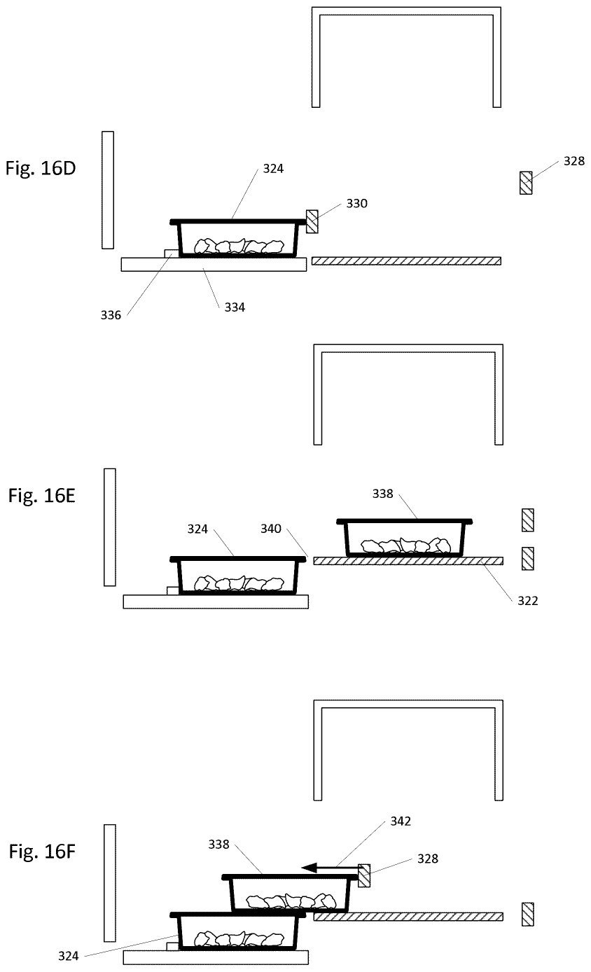

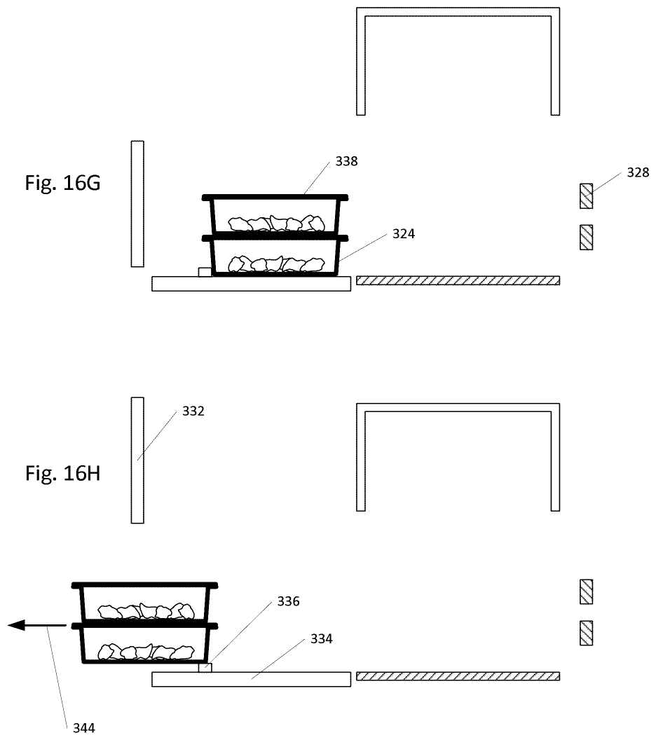

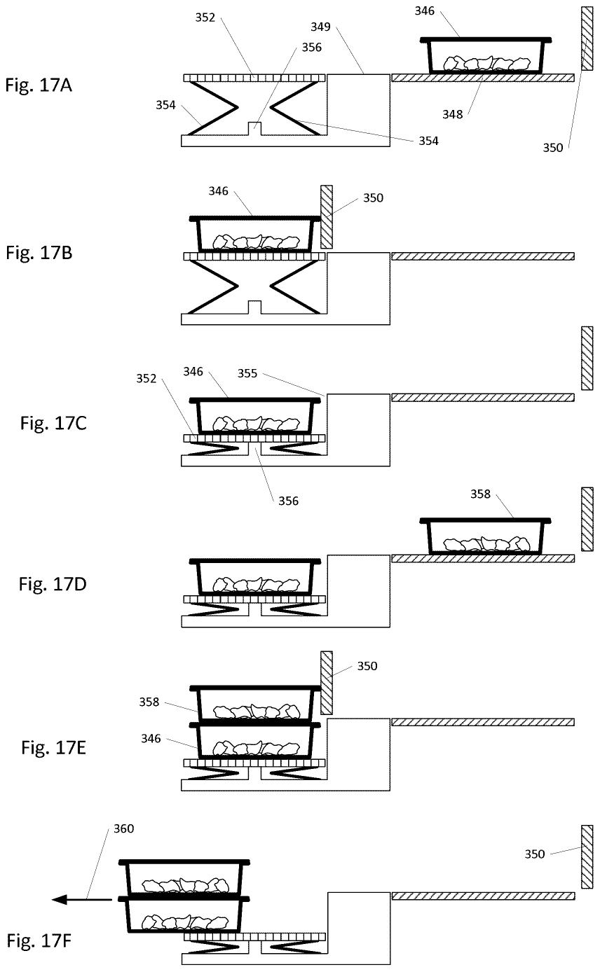

There are essentially four ways for a vending machine to dispense meals that are packaged in two containers. Both containers can be dispensed at the same or different times, and both containers can be dispensed at the same or different location on the machine. Therefore, the four ways are: 1) same time, same location; 2) different time, same location; 3) same time, different location, and 4) different time, different location. Generally, the best consumer experience is provided by the first way, in part since there is little chance for confusion if the entire meal appears at once and can be removed from a single location (e.g., a door that opens to reveal both containers). The embodiments of FIGS. 16A-16H and FIGS. 17A-17F provide such an optimal experience. Generally, the worst experience is provided by the fourth way, which can maximize consumer confusion and is fortunately generally avoidable. The remaining two ways of dispensing provide user experiences that are acceptable though suboptimal. In the case of the 2^{nd} way, the consumer may need to be prompted (e.g., on a screen, by a flashing light, by a sound) to a) remove the first container (e.g., to prevent it from obstructing dispensing of the second) and b) to not assume that the entire meal is held within the first container received, and depart without the second container. In the case of the 3^{rd} way, there is a risk that the consumer will notice one container appearing (in one of two locations) but not the other, and again depart with an incomplete meal. Again, suitable prompts (e.g., sounds, lights) may minimize this risk.

### Automated Vending of Food Held in Multiple Containers

In some embodiments of a vending machine able to serve restaurant-quality meals to a consumer, it is desirable to provide the food in more than one container (e.g., a package with a lid, or a heat-sealed package). For example, there may be more to the meal than can fit in a single container, or different containers are desirable to segregate different portions of a meal, such an appetizer, side dish, or dessert vs. a main dish, or a drink vs. a snack. In some embodiments, other reasons for serving food in at least two containers is to allow separate processing of the food in each container, or to minimize interaction (e.g., chemical, thermal, or mechanical) between some ingredients and others, or to allow the consumer to customize a meal by choosing how much of the contents of one container she would like to add to another container.

For example, in serving a bowl-based meal to a consumer such as a burrito bowl, it is desirable to serve some ingredients at different temperatures than other ingredients, and assuming all ingredients are maintained prior to serving at a cold, food-safe temperature, to heat only some ingredients (e.g., rice, beans, and protein) while not heating—or minimally heating—others (e.g., sour cream, lettuce, which in fact may be damaged by heating). Another example would be a salad with a piece of cooked chicken or salmon on top: In such a case, it is desirable to serve typical salad ingredients (e.g., lettuce, tomato) cold, but to serve the protein hot, and allow the consumer to combine them.

Prior hot food vending machines only deliver a single container to a consumer, in which all ingredients are heated. This greatly limits the quality of meals which include ingredients that are far better not heated, or limits the ability to include such ingredients in the first place. Such machines also provide little or no ability to customize the meal. Customization is possible, e.g., by choosing a particular “base” component (a group of ingredients typically co-located in one container that is heated or not heated)—for example, a combination of particular type of rice, particular type of beans, and particular protein for a burrito bowl—and a particular “topping” component (e.g., a set of toppings such salsa, guacamole, and corn, which may be side-by-side in a single container or in individual compartments (such as portion cups, boats, or trays) to avoid inter-mixing) within another container.

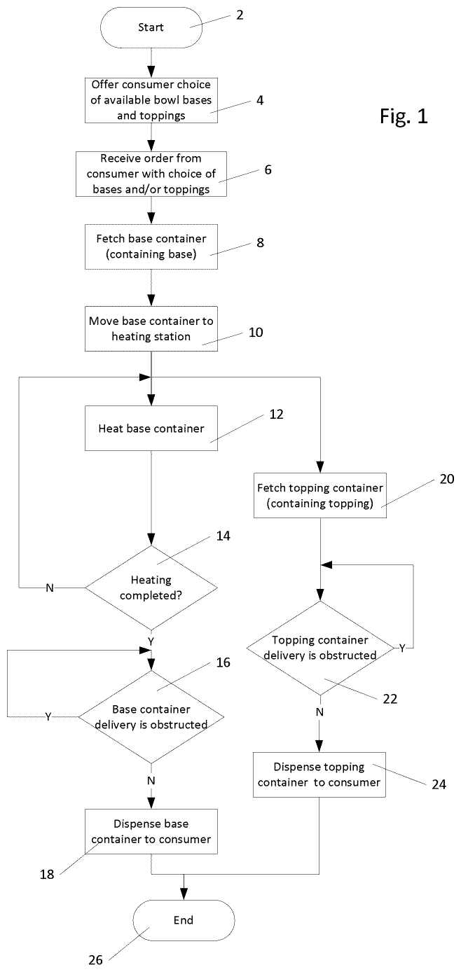

FIG. 1 depicts a process applicable in some embodiments according to which a bowl-format meal having both a base and toppings (more generally, a first and a second container) can be delivered to a consumer from a single vending machine. Once the process has commenced 2, the consumer is offered available bases and toppings 4 and then chooses one of each 6. In some embodiment variations, certain toppings may be pre-matched to certain bases, such that the consumer only is asked to choose the base, for example, and this automatically determines the toppings that go with it. The container containing the base is then fetched 8 from storage (e.g., refrigerated or frozen) within the machine, e.g., by apparatus known to the art of food vending. Assuming the base is to be heated (though not the case with all bowls), the base container is then transported (e.g., by the same apparatus) to a heating station (e.g., a microwave oven) 10 and heated 12 until the desired temperature is reached 14. Once heating is completed, if there is no obstruction 16 (e.g., by the topping container) interfering with delivery of the base container, it is dispensed to the consumer 18.

After the base container has been moved to the heating station, the apparatus can fetch the topping container 20 and dispense it to the consumer 24 if no further processing is required and if there is no obstruction to delivery 22 (e.g., by the base container). At the end of the process 26, the consumer has received both the base and topping container and may transfer the desired amount of each topping in the topping container to the base container, thus forming a complete, ready-to-eat meal (e.g., burrito bowl). In this process, it is assumed that there's a common pathway for both containers (e.g., a single microwave oven, a single shelf or compartment for the consumer to access the containers), thus potentially involving an obstruction of one container by another. In some machine embodiments, there are separate pathways and so checking for and responding to obstruction situations may not be applicable.

In some embodiments, the topping container may be fetched and/or delivered to the consumer before the base container. In some embodiments, the machine is equipped with holding means such as a shelf or compartment which allow the first container fetched from storage to be held while awaiting the second container. In some embodiments, the two containers may be delivered to the consumer at the same time, and in some embodiment variations, the two containers can be grouped together in delivery (e.g., one container stacked upon the other, optionally joined together).

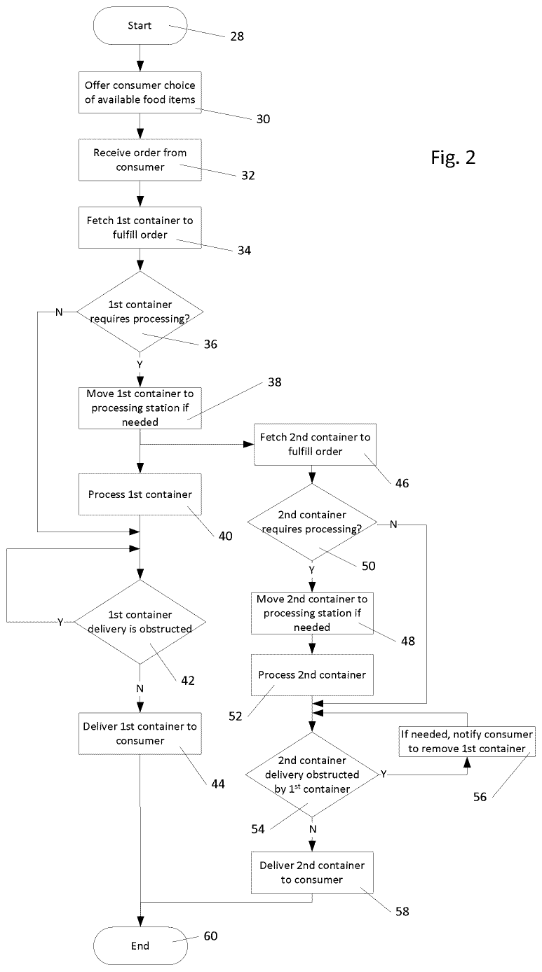

FIG. 2 depicts a process flow that is more generic than that of FIG. 1 in which a food order comprising both the contents of a first container and a second container is delivered to a consumer from a single vending machine in some embodiments.

Once the process has commenced 28, the consumer is offered available food items 30, some of which are associated with the first container, and some of which are associated with the second container. The consumer then chooses one container as the first container and one container as the second container 32 (in some embodiment variations, certain second containers may be pre-matched to certain first containers, such that the consumer only chooses one of the containers and the system automatically determines the second container that accompanies it). The first container is then fetched (i.e., retrieved) 34 within the machine by apparatus and if it requires processing (e.g., heating, cooling, agitation) 36, the first container is then transported (e.g., by the same apparatus) to a processing station 38 and processed 40 until the desired end condition is reached. Once processing is completed, if there is no obstruction (e.g., by the second container) 42 interfering with delivery of the first container, it is delivered to the consumer 44.

After the first container has been moved to the processing station, the apparatus can fetch the second container 46 and deliver it to the consumer 58 if no other processing is required 50 (or instead, deliver it to a different processing station 48 for processing 52 if a different form of processing is required) and if there is no obstruction to delivery 54 (e.g., by the first container). If there is an obstruction by the first container, the consumer can be notified 56 to remove the first container. At the end of the process 60, the consumer has received both the first and second container and may transfer the desired amount of food from one container to the other to at least partially customize the food she is preparing to consume.

The processes described above can of course be extended to delivering to the consumer more than two containers, each containing one or more food items which have been combined or isolated in separate containers for one reason or another, some examples of which have been cited above.

Automated Vending of Food in which Different Components are Differentially Heated

In some embodiments, using a vending process and apparatus food may be served that is packaged in such a way that components of the food—each a single ingredient or combination of ingredients, and all initially kept at a foodsafe cold temperature—are differentially heated according to a desired temperature, or not heated at all, before serving. For example, in serving a taco in which various components are served separately but combined by the consumer before eating, there may be three components: 1) a hot taco filling (e.g., meat and certain vegetables), 2) cold toppings such as salsa, shredded cheese, lettuce, sour cream, guacamole, and 3) one or more warm or hot tortillas. Normally, if all three taco components are put into a single package and heated in an oven, all will become hot. This can badly effect the mouthfeel of the taco and in some cases damage ingredients (e.g., wilted lettuce, separated and curdled sour cream). However, it can be very desirable to present a taco in a single package (or group of packages that are dispensed in a short time period). To do so requires a way to differentially heat different components that are in an oven all at the same time. In some embodiments a microwave oven (or one in which microwave radiation plays an important role) is provided for heating components. Normally, microwave ovens are designed to maximize uniformity of heating, but the objective herein is to provide non-uniform/differential heating of different components, in a controlled manner.

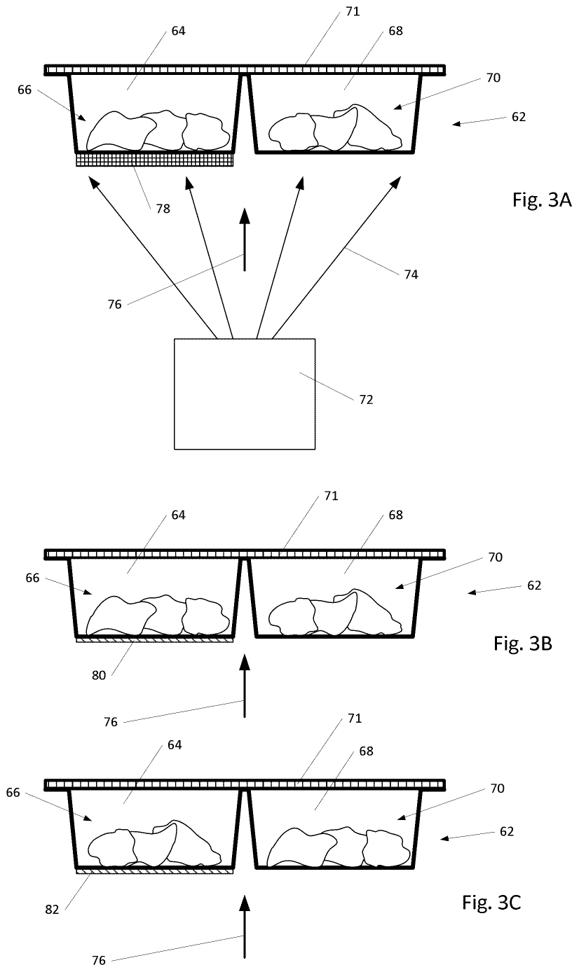

FIG. 3A depicts in cross-sectional elevation view a container 62 used in some embodiments having at least two compartments, one 64 with food component A 66 (intended to remain cool or be less heated) and one 68 with food component B 70 (intended to be warmed or heated), and optional lid 71. Either or both of the compartments may in some embodiments contain sub-compartments or containers such as portion cups to separate ingredients with the compartments. The container is placed in a microwave oven chamber (not shown) with the microwave source 72 below (e.g., a magnetron is below the container or a waveguide is provided) and with microwave energy 74 directed upwards 76. The microwave source 72 preferably has a small radiating aperture. Since only one such source is provided (in particular, none emitting in other directions), the radiation emitted can be effectively attenuated (ignoring reflections such as from metallic oven walls, which in some embodiments may be mitigated by adding microwave-absorbing materials as in an anechoic chamber) by interposing a suitable shield between the source and an item to be shielded, such that the item is in effect in the ‘shadow’ of the shield.

In the figure, a microwave ‘shield’ 78, considered herein to be an absorber (and/or reflector) of microwave radiation, is positioned between the microwave source and the ‘cool’ compartment, e.g., attached to the bottom of the compartment on the outside (or in some embodiments, the inside). The design of the shield, including suitable materials, is discussed below. The shield absorbs at least a portion of the microwave radiation incident on it (which generally causes it to heat) such that the energy that is transmitted through the shield is decreased. Food component A, in the ‘shadow’ of the shield, is thus heated less than component B, which is unshielded in the arrangement shown. In a sense, the shield has a ‘sacrificial’ role, though it may not literally be sacrificed and may be undamaged as a result of its heating.

FIG. 3B is a similar view as FIG. 3A but in which the shield 78 is replaced by a reflector 80 of microwave energy. The microwave source 72 is below the container and not shown. The reflector 80 is shown attached to the bottom of the ‘cool’ compartment, but again may be separate from it or on the inside of the compartment. Assuming the reflector is a coating (e.g., metallic) applied to a substrate, the reflective surface is oriented toward the microwave source (not shown). In this case, microwave energy is not necessarily absorbed, but it is reflected away from component A, which similarly is heated less than component B. Since microwave reflections can in some situations damage the microwave source (e.g., a magnetron), in lieu of a reflector a shield might be used instead.

FIG. 3C is a similar view as FIG. 3A but in which a microwave susceptor 82 is used instead of a shield or reflector in some embodiments, to achieve the opposite effect. Susceptors—well known to the art—are designed to preferentially absorb microwaves and heat up, e.g., so as to brown the surface of nearby food or pop popcorn. With the susceptor positioned adjacent (outside the container or inside the compartment 64) to component A 66, component A 66 may be heated more than component B 70. The microwave source (not shown) is assumed to be below the container, however it may be in a different location.

However, in some embodiments by providing an insulator (e.g., an air gap, a low-thermal conductivity material), not shown, between the susceptor 82 and the compartment or food component, the susceptor—especially if designed for high absorption and minimal transmission—can act as a shield. Although it heats due to microwave absorption, its high thermal isolation from the compartment/food component can make it effective in this application.

Shields may be placed on the inside or outside of a container, or at some distance from it, with an air gap or other insulator providing a thermal barrier to reduce thermal conduction to the food component to be keep cooler. Reflectors can be similarly located, but may not benefit from a thermal barrier. Susceptors, however, should be placed in close proximity to the component to be preferentially heated.

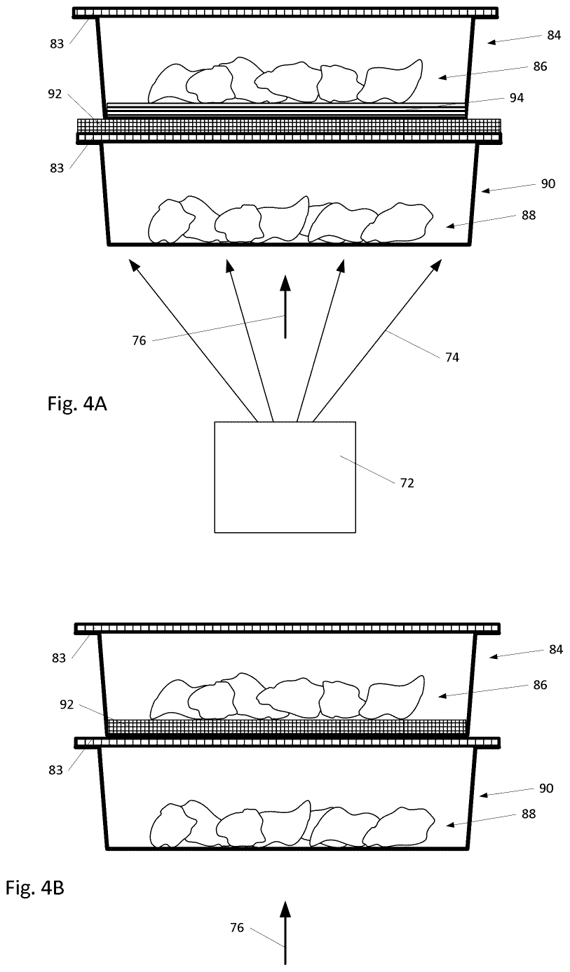

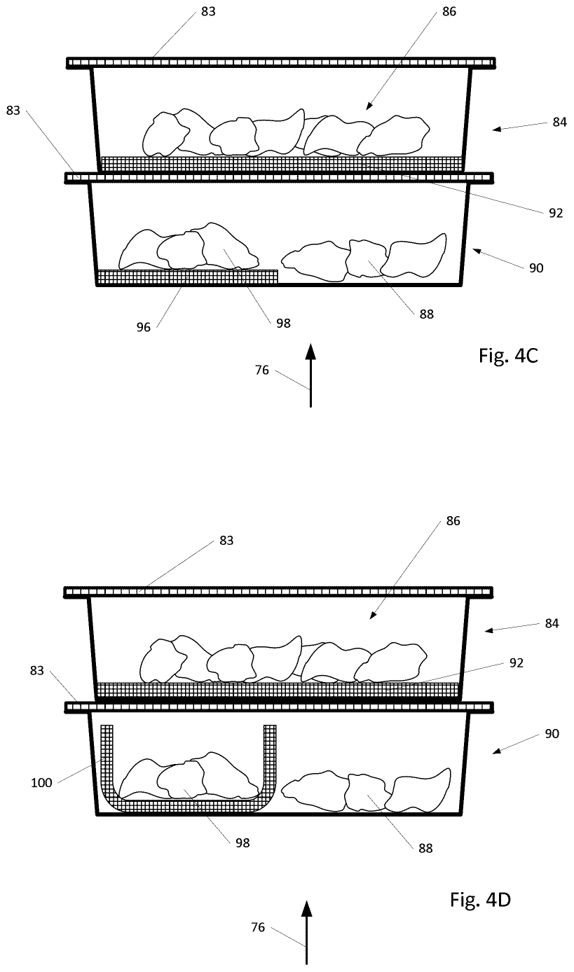

FIG. 4A depicts a cross-sectional elevation view of two containers provided in some embodiments, each with lid 83. The upper one 84 contains a food component A 86 intended to remain cool, or at least, less hot than food component B 88 within the lower container 90. Below the two containers is a microwave source 72 with microwave radiation 74 directed upwards 76. In between the containers a shield 92 is provided so that at least some (and in many cases, most or all) of the microwave radiation passing through the lower container 90 and through food component B 88 is intercepted by the shield before it reaches component A 86 in the upper “cool” container 84. The figure also shows an optional thermal insulator 94 within the upper container; this insulator might also be located external to the container. In some embodiment variations, air can serve as the insulator; for example, the bottom of the upper container may include protrusions/standoffs (e.g., molded into the container) so that there is little contact between the container and shield. Again, the purpose of the insulator is to minimize heat transfer to the upper container due to conduction or possibly, convection, from the shield which in many embodiments becomes hot as it absorbs microwave radiation. The insulator might also include a reflective element to prevent radiative heat transfer from the shield, and in some embodiments also serve to reflect at least some of the microwave radiation.

FIG. 4B is similar to FIG. 4A but depicts an embodiment in which the shield 92 is within the upper container 84, located at the bottom below component A 86. In some embodiment variations, an insulator above the shield (not shown) may also be provided. The microwave source is below the container and not shown, with radiation directed upwards 76. In some embodiment variations, the shield can be embedded in the container bottom, forming a ‘false floor’ for the container. For example, two ‘nesting’ containers of similar shape but with different depths can be used, with the shallower container affixed within the deeper container. This allows the shield to be hidden, and especially if there is a space between the shield and false floor (e.g., an airspace, or a space filled with insulating material) also provides some insulation between shield and container bottom, minimizing heat flow to the upper container. A space can also be provided between shield and the outside of the upper container, improving safety (minimizing the risk of burns if the shield becomes hot). In some embodiments (not shown) the shield is within the lower container, but above component B (e.g., it may be attached to the lid of the lower container. In some embodiment variations, a removeable band may hold the two containers together allowing the machine to manipulate them as one.

FIG. 4C depicts an embodiment similar to that of FIG. 4B, but in addition to the shield protecting the upper container, there is a shield 96 (possibly less radiation-absorbent, e.g., thinner) and smaller than the container to shadow a portion of the food in the lower container (a “warm food component”) 98 so that it is not heated as much as another component in the same container. In this manner, at least three components, each with a different desired serving temperature, can be co-packaged. The microwave source 76 is below the container and not shown. In some embodiment variations, the upper shield 92 is located between the containers as in FIG. 4A, or incorporated into the lid of the lower container. A reflector might also be used instead of a shield in these locations. An example of an application of the configuration in FIG. 4C is a taco meal in which the upper container includes toppings (e.g., in individual containers or in compartments), and the lower contains both a filling (without a shield) and flat, folded, or rolled tortillas protected from overheating (which can cause dehydration, and risk burning one's fingers if too hot) by shield 96.

In some embodiment variations, the upper container has a partial shield (allowing some components in the upper container to be cooler than others). In addition to shields, reflectors or susceptors may be partial.

FIG. 4D depicts an embodiment similar to that of FIG. 4C but the partial shield 100 in FIG. 4C is now shaped so as to more fully protect from overheating the warm food component. The microwave source is below the container and not shown, with radiation directed along arrow 76. The shield may be shaped as a “U” as shown, as a cylinder that surrounds the food component, as a blanket, as a bag, as a closed box, etc. In addition to further protecting the food component, the shaped shield may help stabilize the position of the component so it doesn't move away from the shield, etc. The shaped shield may be attached to the container or removable. Similarly, partitions or other structures in a container may constrain the position and/or orientation of food components relative to a shield, susceptor, or reflector. In addition to shields, reflectors or susceptors may be shaped.

The upper shield 92 of FIG. 4D may in some embodiment variations be located between the two containers, or in the lid of the lower container.

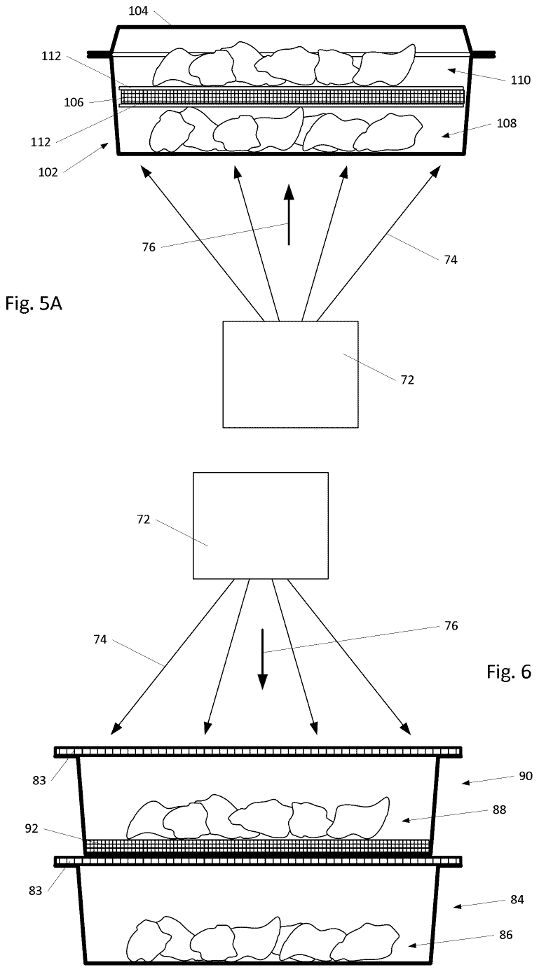

FIG. 5A is a cross-sectional elevation view depicting a single container 102 which in some embodiments incorporates a shield to implement differential heating of components above and below the shield. Such an arrangement may use less packaging material than arrangements using two containers as discussed previously. The container 102 includes a lid 104, which may be separate or attached to the container (i.e., a ‘clamshell’ design). The food components can be dispersed in the containers as shown, or be isolated within individual bowls or cups, or by partitions, within each container. As depicted, a shield 106 is interposed between one or more lower (warm/hot) components 108 and one or more upper (cool) components 110. The shield may directly rest on the lower component(s); however, a separator 112 (e.g., parchment paper) as shown may be helpful. The separator may have thermally insulating properties as well as grease and/or moisture resistance. Similarly, the upper component(s) may rest directly on the shield, but again, a separator 112, as shown, may be helpful. The shield may also rest on standoffs or partitions (e.g., molded-in) to the lower container. “Cool’ food component(s) may be retained in the lid (e.g., by a peelable film) such that when it is removed or swung open (in the case of a clamshell), those components are moved out of the way, facilitating access to the shield and ‘warm’ food component(s). In the same way that partial or shaped shields, reflectors, or susceptors may be used in two-container embodiments as discussed, they may also be used in a single-container embodiment as in FIG. 5A. In some embodiment variations, the top of the shield may include a structure (e.g., cardboard) designed to receive containers (e.g., portion cups) holding components separate above the shield, or a compartmented tray insert may be used. Partial and shaped shields, reflectors, and susceptors as previously described may be used in a single-container configuration as well. FIG. 5B (on Sheet 9) depicts an arrangement similar to that of FIG. 5A, but in which a compartmented tray 111 is used above the shield.

In some embodiments, the shield (and any separators, possibly attached to the shield) may be located at a parting plane between container and lid, allowing the shield to be pulled out along that plane, and allowing food components above the shield to fall onto the (hotter) food components below the shield, thus “assembling” a meal comprising components at different temperatures.

FIG. 6 shows an arrangement similar to that of FIG. 4B, but in this case, the microwave source 72 is above the two containers (or a single container as in FIG. 5, as the case may be), with the radiation directed downwards 76. In this case, the lower container 84 would contain a food component 86 that should not be heated (or only slightly heated) and the upper container 90 would contain one or more components 88 to be significantly heated.

The shield 92 of course can be located between the two containers or in the lower container above the cool food component, such as below the lid of the lower container.

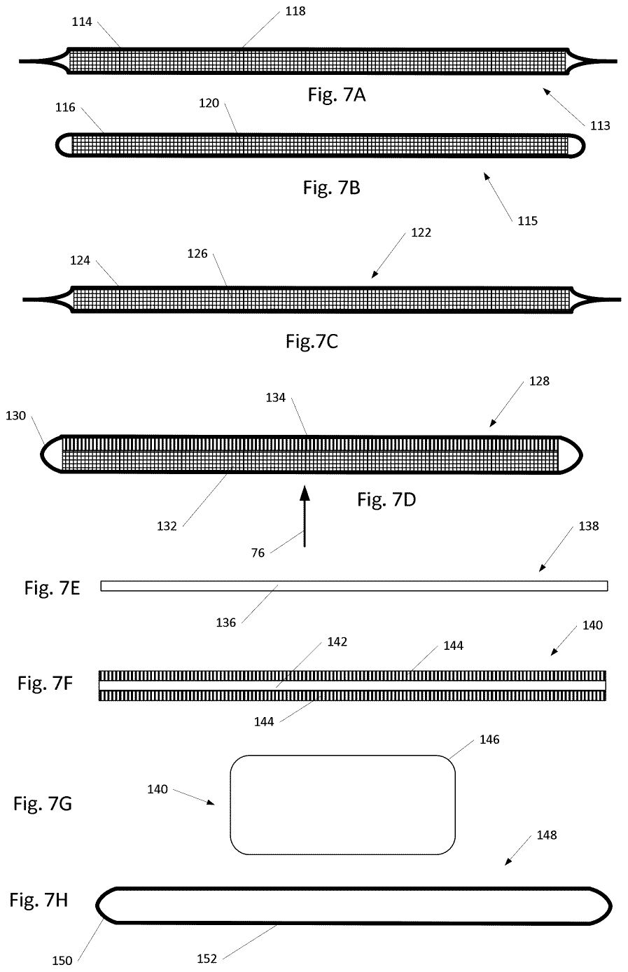

FIGS. 7A-7E depict in cross-sectional elevation view several designs of shields in some embodiments. Shields may be freestanding and ‘bare’ or may be enclosed (especially if comprising a liquid component (e.g., water, a strong absorber of microwaves at the frequency used in microwave ovens) in a pouch or other structure to contain them. Gels that are sufficiently viscous, may be in direct contact with the container (e.g., below a false floor). FIGS. 7A-7B show shields 113, 115 comprising pouches 114, 116 containing for example a solid absorber 118, 120 having interconnected porosity, along with water. Examples of such absorbers include sponges (e.g., cellulose, synthetic, natural), sponge clothes, towels, etc.) all of which may be at least partially saturated with water. To reduce the risk of water being heated so much that it boils, certain solutes may be added to water to raise the boiling point. For example, sugar can both raise the boiling point and slightly increase microwave absorption, while sodium chloride (e.g., at saturation concentration) can raise the boiling point, increase radiation absorption, and serve as an antimicrobial agent. It can also be desirable to incorporate a weak element in a pouch (e.g., a peelable region) such that if boiling does occur, steam pressure can be vented rather than causing the pouch to inflate and disturb the food, package, etc.

FIG. 7C depicts in cross-sectional elevation view a shield 122 comprising a pouch 124 similar to that of FIG. 7A, but in this case, rather than a solid porous absorber and a liquid such as water, the pouch contains a gel 126 having a high microwave absorption. One example is a gel comprising water and a superabsorbing polymer such as sodium polyacrylate. Other examples of gels include those made with konjac glucomannan, carboxymethyl cellulose, gellan gum, xanthan gum, and combinations thereof. For example, a water-based konjac gel can be formulated with a high concentration of sodium chloride, the salt both providing antimicrobial properties to increase shelf stability, and increasing microwave absorption.

Absorbers can be hydrogels, infused aerogels, heat-stable gels (i.e., those which remain crosslinked when heated to temperatures of interest, e.g., up to the boiling point of water) of any kind, clays, plant materials, sorbents (e.g., corn cob-based, vermiculite, polypropylene, cellulose, natural sponge, superabsorbent polyurethane foam (e.g., Aquazone (Reilly Foam Corporation, King of Prussia, PA).

Absorbers can be made also of ferrite, carbon-loaded polymer (e.g., polyurethane or polystyrene), and can have be flat, be covered with small pyramids, etc.

FIG. 7D depicts a combined shield/thermal insulator 128 comprising a pouch 130 containing both a microwave absorber 132 (absorbing microwaves from direction 76) and a thermal insulator 134 on one (as shown) or more surfaces. For example, the absorber may be a foam layer having interconnected porosity whose pores contain water, and the insulator may be a foam layer having closed pores, etc.). In lieu of a thermal insulator, the microwave absorber can be suspended so it is surrounded by air on at least one side.

Food items themselves especially if high in water content, may be used as microwave shields. For example, as shown in depict in the cross-sectional elevation view of FIG. 7E, a slice of watermelon 136 can be an effective shield 138. Such water-containing, food-based shields may need no enclosure, since direct contact with the food they're shielding may be acceptable.

Depending on the component to be shielded, various characteristics of the shield may be varied, either globally for the entire shield or more locally. Such characteristics include thickness, fill factor (percent of the shield that contains an absorber such as water: there may be regions of the absorber made impermeable to a liquid absorber), material composition, overall water content, percent of water in a mixture that also includes another liquid which does not strongly absorb microwaves at the frequency of the magnetron.

In addition to water-containing materials, other candidate materials for use in or as shields include fats and oils, sugars (e.g., corn syrup, honey), carbon black, graphite, certain polymers, and certain ceramics (e.g., containing metal oxides). Materials with polar molecules or conductive properties may be useful in this regard.

Shields and/or insulators can be made biodegradable, recyclable, compostable, etc. like the package. For example, a shield can be made from konjac gel enclosed in a compostable zipper or heat-sealed bag. If shields are intrinsically not compostable or recyclable (e.g., a typical susceptor), they can be designed to be removed before composting or recycling other packaging consumables.

FIG. 7F depicts a cross-sectional elevation view of a shield 140 in which a solid RF energy absorber 142 (e.g., a susceptor) is sandwiched between thermal insulators 144 on one or both (as shown) sides so that it can serve its function of reducing transmission of energy through it while minimizing the transfer of thermal energy (it heats up due to absorption of RF) to the food and surroundings (e.g., it's important to avoid skin contact with a hot susceptor). Corrugated cardboard is an example of an efficient insulator that is inexpensive. In a container such as that shown in FIG. 4B, shield 92 may comprise a susceptor the upper face of which can serve as the floor of the container that is in touch with food or with containers such as portion cups and other items in that container such as utensils.

To avoid the risk of arcing, the shield 140 (or at least the microwave-absorbing conductive portion thereof) should be designed with rounded corners 146 as shown in the plan view of FIG. 7G to fit a rectangular or square container, or be circular to fit a round container.

Regarding the design of reflectors, with the caveat that they need to be designed carefully to avoid reflections that damage the microwave source, these can be made from solid metal, or from another material coated with metal. In a microwave oven, it is generally desirable to avoid sharp corners to minimize the risk of arcing. Therefore, a disk (e.g., plastic) 148 with rounded edges 150 such as that shown in the cross-sectional elevation view of FIG. 7H may be used in some embodiments if metallized 152 on the outside, or a solid metal disk of similar shape may be used. A hollow, flat balloon or bladder that contains gas or liquid can also serve as a reflector.

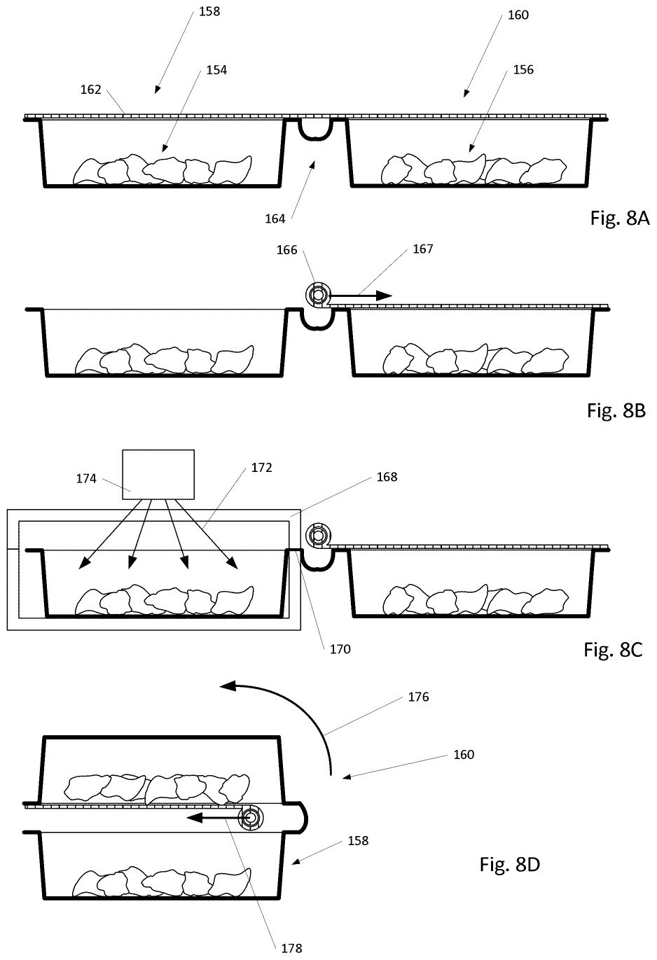

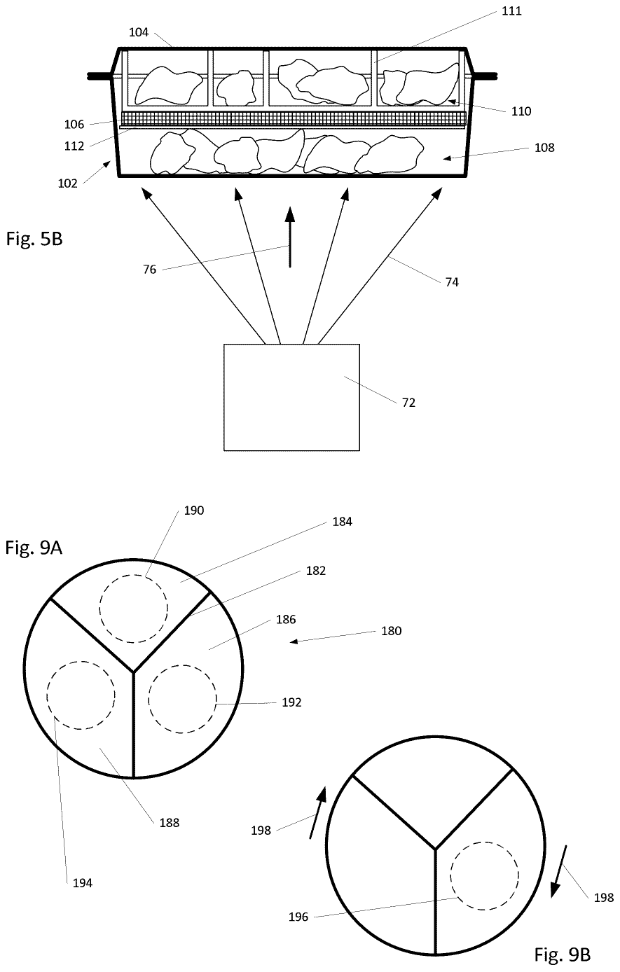

FIGS. 8A-8D depict in cross-sectional elevation views steps in the preparation of food in some embodiments, comprising a component to heat 154 and a component not to heat 156. The former is in a lower portion 158 of a clam shell-style container, and the latter in an upper portion 160 which is initially rotated into an open position as shown, or at least not overlying the lower portion. A continuous film 162 is shown overlying and sealing the components in both portions, and there is a hinge 164 that joins both portions and allows one to rotate relative to the other. In FIG. 8B, the film has been pealed back (fully as shown 166 in the direction of arrow 167, partially, or not at all) from the lower portion 158 and in FIG. 8C, the lower portion 158 has been inserted into a microwave (or other type of oven, such as convection) oven chamber 168, with the hinge area extending through a narrow gap 170 in the wall of the chamber. While so arranged, microwave energy 172 is applied from microwave source 174 to heat the component in the lower portion. After the container is removed from the oven as in FIG. 8D, any additional peeling of the film 162 covering the lower portion may be continued (automatically or manually), and then the upper portion 160 is rotated 176 to be over the lower portion and the peeling of the film holding in the component in the upper portion may be carried out as shown by arrow 178. In some embodiment variations, there are two separate films, each peeled independently. In some embodiment variations, the lower portion is peeled fully or partially only if needed for venting, and the package is otherwise presented to the consumer with films attached. The consumer can then transfer the contents of the upper container into the lower container manually (e.g., using a spoon). In some embodiments, the lower portion might not have a film covering it initially if it has a removeable lid, or if the container is stored and handled with the ‘clamshell’ closed, then the film on the upper portion can serve to contain and somewhat (not hermetically) seal the contents of the lower portion.

FIG. 9A depicts in plan view a bowl or plate 180 in some embodiments with optional partitions 182 forming bento box-like compartments, and containing components 184, 186, and 188 arranged side-by-side which are to be heated differentially (e.g., cold, warm, hot). Below (or above) each compartment is a dedicated microwave source (e.g., a magnetron, or a waveguide/power splitter arrangement) 190, 192, and 194 which can be adjusted (e.g., power level, duty cycle) to optimally heat a particular component and whose radiation pattern is well defined, localized, and narrow enough to minimally effect other components. FIG. 9B depicts a similar arrangement but one in which a single microwave source 196 is used and the bowl or plate is rotated as shown by arrows 198 (or in some embodiments, translated, or both rotated and translated). However, unlike a typical microwave oven in which the rotation is at a constant speed and covers a full 360 degrees, here the vessel is rotated (in one direction or oscillated) with variation of speed and/or range of angles, such that the components to be more fully heated are exposed for longer to the radiation vs. those which are not to be heated, etc. Modulation of the microwave source intensity (e.g., power level or duty cycle) may also be used.

In some embodiments a specially-designed microwave oven may be provide having no stirrer/antennas and in which standing waves, having both nodes and antinodes are encouraged to form. In such an oven, components intended to be cooler can be located at nodes and those intended to be warmer can be located at antinodes.

To the extent that microwave reflections are minimized and there is a well-controlled (often constant) flux of microwave radiation relative to the food components (e.g., possibly reduced rotation of food within the chamber, possibly less ‘stirring’ of the microwave radiation pattern), there can be significant flexibility in the placement of shields and reflectors to project food components. In some embodiments, the walls of the microwave oven chamber are covered with absorbing elements (e.g., ferrite, conductive foam (e.g., array of small pyramids) to minimize reflections, approximating a microwave anechoic chamber.

In some embodiments there are multiple magnetrons and different magnetron positions, including magnetrons on the side of the oven.

In some embodiments, susceptors may be used including partial and shaped susceptors, to increase warming.

The machine controller needs to identify which containers are to be heated, and by how much, and which are not to be heated or heated to a lower temperature. Heating times for different containers in some embodiments are provided by identifiers such as QR codes or RFID tags attached to containers. In other embodiments heating times are based on machine vision analysis of what components are within the container (assuming imaging can be performed through the container or its lid.

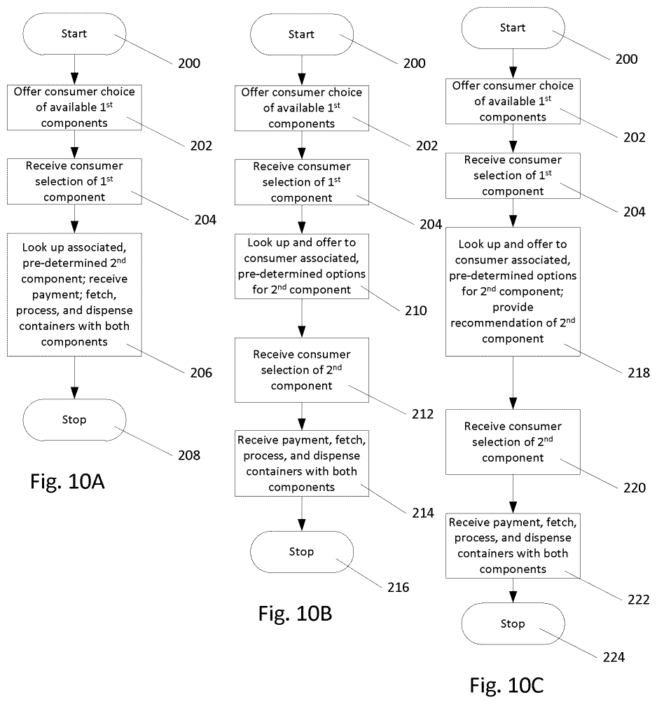

FIGS. 10A-10C depict flowcharts describing a process in some embodiments by which a consumer can order a meal comprising first and second components, each of which is in its own container, which can allow for customization of the meal. In some embodiments, selection of a first component strictly and automatically determines selection of a second component, without further consumer input (e.g., in the case of a chef-designed bowl). In other embodiments, selection of a first component generates a set of optional second components, which may be a subset of all available second components based on culinary compatibility with the first component, for example. The consumer then selects among these second components with all of them presented equally. In other embodiments, selection of a first component generates a set of optional second components (which again may be a subset of all available second components based on culinary compatibility with the first component, for example) but a recommendation for the second component is also provided. The consumer then selects among these second components, possibly influenced by the recommendation.

In FIG. 10A, the process commences 200 after which the vending machine controller offers the consumer her choice of first components 202 that are available. The consumer's selection is then received in 204. In 206, the controller identifies a pre-determined second component associated with the selected first component, e.g., by accessing a database. Also in 206, the controller signals the consumer that payment for the meal is required and confirms that payment is completed. Also in 206, the controller directs the vending machine to retrieve the first and second components, process (e.g., heat) one or both as specified in an electronic record for each component (in some embodiment variations incorporating real-time feedback, e.g., from temperature sensors in the oven), and dispense the containers, completing the vending process 208.

In FIG. 10B, the first three elements 200-204 are similar to those of FIG. 10A, but in element 210 the controller identifies not a single pre-determined second component but rather, a set of suitable second components, and presents them to the consumer. Suitability may in some embodiment variations involve individual preferences or nutritional goals for the consumer known to the controller, or other factors. In 212, the consumer's selection of the second component is received, and in 214, the controller directs the vending machine to retrieve the first and second components, process (e.g., heat) one or both (for some meals, one component may be heated, though less than the other component versus not at all), and dispense the containers, completing the vending process 216.

In FIG. 10C, the first three elements 200-204 are similar to those of FIG. 10B, but in element 218 the controller not only identifies a set of suitable second components, presenting them to the consumer, but also makes a recommendation for the second component. The recommendation could be based on stored information about the meal (e.g., provided by the chef), information about the particular consumer, etc. In 220, the consumer's selection of the second component is received, and in 222, the controller directs the vending machine to retrieve the first and second components, process (e.g., heat) one or both, and dispense the containers, completing the vending process 224.

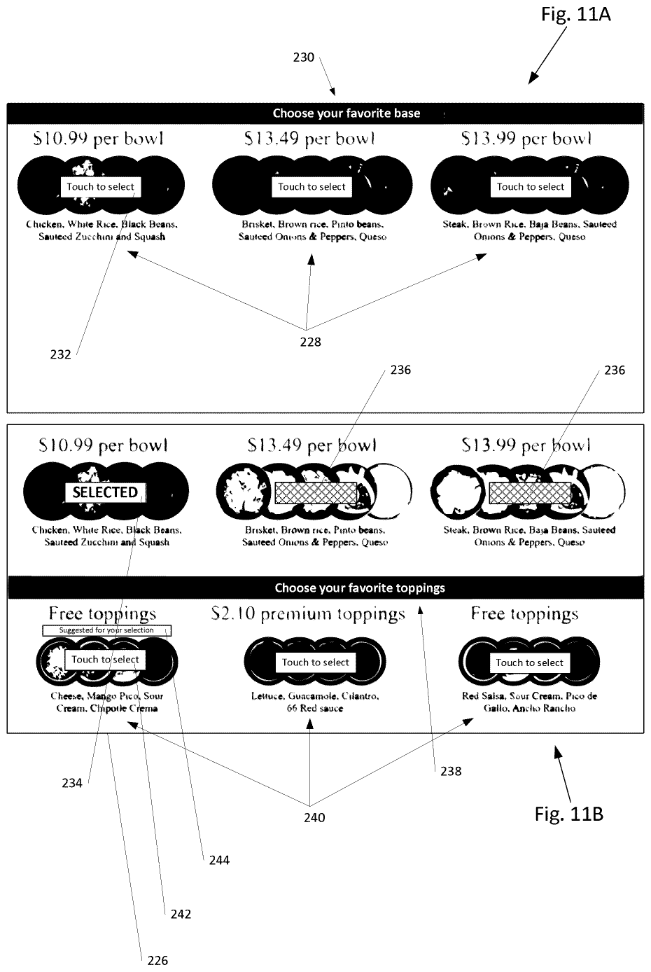

FIGS. 11A-11B depict successive displays in an exemplary user interface (e.g., within the boundaries 226 of a screen such as a touchscreen) in some embodiments that assumes an ordering process similar to that of FIG. 10C. In FIG. 11A, several (here, three) available (e.g., in-stock, not expired) first components 228 are displayed, along with prompt 230 and means for selecting the first component such as an on-screen buttons 232. In the example shown, the left-most first component will be selected, transitioning the display to that of FIG. 11B. In that figure, display item 234 indicates that the left-most component has now been selected, and other first component options are no longer available (e.g., greyed out buttons 236). Prompt 238 is now displayed requesting the consumer select among several (here, three) available second components 240 (which may be a subset of available second components) are now also displayed (unlike when selecting the first component, to avoid confusion) using one of another selection method such as buttons 242. Also provided is a recommendation 244 for one of the second components. Once the consumer selects a second component, the process 222 in FIG. 10C can continue.

In some embodiments, both components may be displayed and available to select in either order, but rules would still be enforced such as the need to select one first component and one second component only.

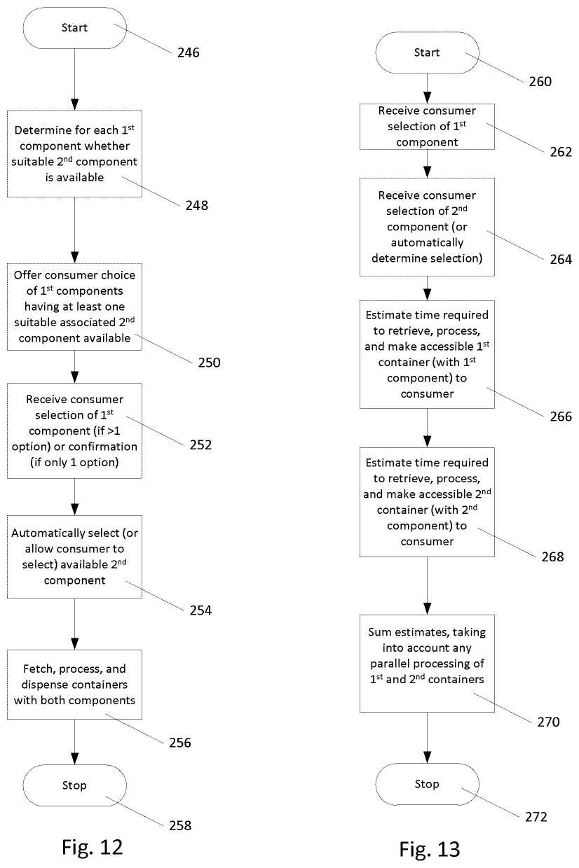

For a meal that comprises two components, it would be undesirable to display (as in FIG. 11) an option for a first component if there is no suitable second component available to go along with that first component. It should be noted that some second components, though available, may not be suitable due to an incompatibility of flavor(s), mouthfeel(s), etc. with a given first component. Thus, the process of FIG. 12 depicts a process used in some embodiments for vending machine ordering of two components of a meal which accommodates this concern. In the figure, the process starts 246 after which the machine controller determines 248 for each available first component whether there's a suitable second component. In 250, the controller—rather than displaying all available options for the first component—displays only those first component options having a suitable available second component. In flowchart element 252, the controller receives the consumer's selection of the first component. However, if only one first component is available, the controller would simply seek confirmation that the consumer wishes that component. In 254, the controller automatically selects a designated second option, or provides a choice with or without recommendation (as discussed earlier in conjunction with FIGS. 10A-10C. In 256, the controller directs the vending machine to retrieve the first and second components, process (e.g., heat) one or both, and dispense the containers, completing the vending process 258.

FIG. 13 depicts a process used in some embodiments whereby the time from order placement to meal dispensing (of a meal separated into two or more containers) is estimated. Such an estimate is useful, for example, to inform the consumer (e.g., on-screen) as to when to expect a meal ordered at the machine, or to allow scheduling of meals ordered in advance, e.g., similar to that described in U.S. Pat. No. 11,610,276.

The process of FIG. 13 commences 260 after which the controller receives 262 a consumer selection of the first component, proceeding on to receiving a consumer selection 264 (unless automatically determined) of the second component. Then the time required to retrieve both containers, process (e.g., heat) one or both (typically differentially if both are heated), and make them accessible to the consumer is estimated (266, 268). In 270, the estimated time associated with these times is determined, e.g., by summing. However, any activities associated with the second container which may overlap those associated with the first container, allowing parallelism, needs to be taken into account when obtaining the estimate. By 272, the process has stopped and the estimate is available.

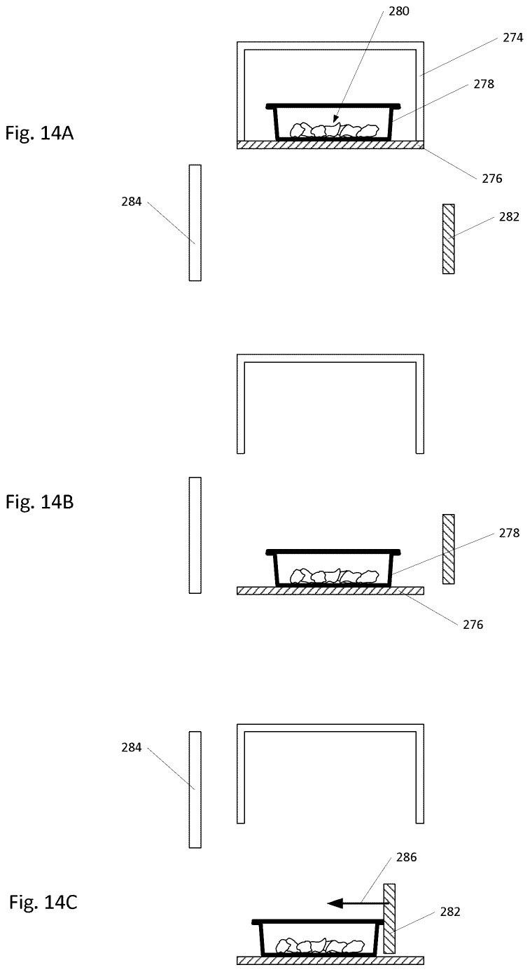

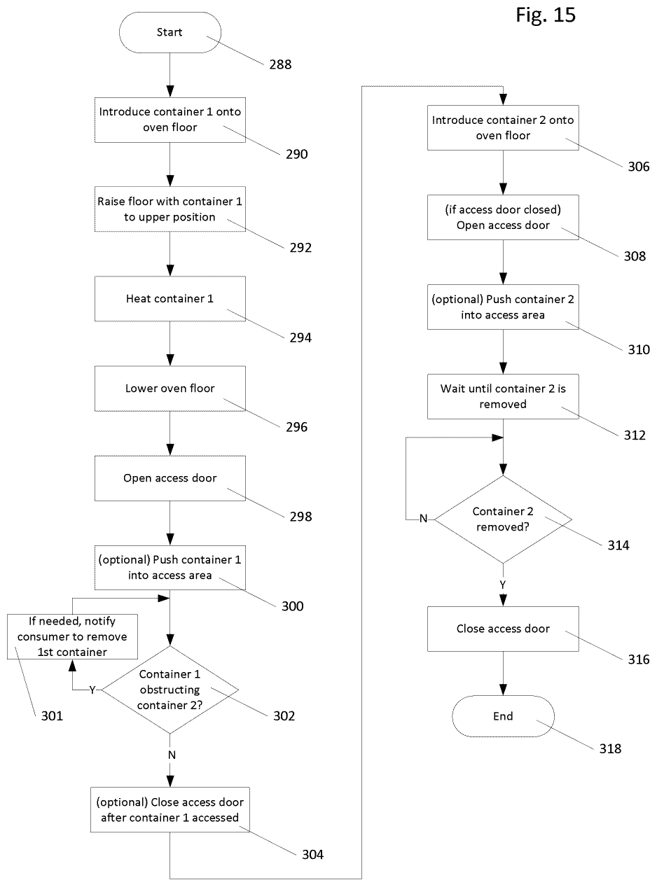

FIGS. 14A-14C depict in cross-sectional elevation view a portion of a vending machine used in some embodiments (whose process flow is described in FIG. 15) at different times. In FIG. 14A, an oven (e.g., microwave) is shown comprising an oven chamber 274 and an oven floor 276, which can move vertically. In FIG. 14A, floor 276 is in an upper position where it forms a closed vessel (e.g., one that prevents escape of microwave radiation) in combination with chamber 274. Microwave ovens designed as described are not uncommon in current hot food vending machines. Also shown in FIG. 14A is container 278 with food to be heated 280 inside of it. Below the oven chamber is pusher 282 shown in a retracted position so as not to interfere with motion of floor 276. Opposite the pusher is access door 284 shown in the figure in closed position.

In FIG. 14B, floor 276 has descended to a lower position with meal 278 which has now been heated. Lastly, in FIG. 14C, door 284 has moved upwards to provide access to the meal, while pusher 282 has moved at least partway in the direction of arrow 286, pushing the meal toward the consumer to provide better access.

FIG. 15 depicts a process governed by the vending machine controller according to which a machine design of the kind shown in FIGS. 14A-14C may function in some embodiments. The machine in question serves a meal in two containers (one heated, one unheated), dispensing both containers at a common access location, but at different times (the second way described in Paragraph 44 herein). Due to the common location, and especially if both containers must pass through the oven used for heating, there is potential for one container to obstruct the movement of the other. The process of FIG. 15 therefore includes an algorithm that enables both containers to be dispensed.

Once the process commences 288, the first container is introduced 290 onto the oven floor 276. Then in 292, the floor—supporting the first container—is raised to the upper position such that the container is now within a closed oven. In 294 the first container is heated after which in 296 the container is lowered with the oven floor. At this time, access door 284 is opened 298. If it is not practical or desirable for the consumer to reach in to retrieve the first container, pusher 282 may then be actuated by the controller to push 300 the container into an access area where the consumer can readily retrieve it. In 302 the controller determines whether the first container is in a position where it might obstruct the motion of the second container. If so, the consumer is notified 301 and the process waits until the first container is removed. If not, the process continues with 304, in which the access door may be closed if desired (e.g., if there's a potential hazard to the consumer from the next step). In 306, the controller fetches (if not already fetched) the second container and moves it onto the oven floor. Since the second container requires no heating, it is ready to be dispensed. If the access door has been closed, it is opened in 308 after which the container is pushed in 310 into the access area if desired to facilitate or needed to enable consumer access. The controller then waits 312 until the second container is removed and this is verified in 314. Once verified, the access door is closed 316 and the vending process is complete 318.

In some embodiments, the process of FIG. 15 is modified such that the first container is unheated and dispensed promptly, and the second container is heated and dispensed after heating.

FIGS. 16A-16H depict in cross-sectional elevation view a process used in some embodiments for dispensing two containers in a vending machine in which both containers are provided to the consumer at the same time and same location (the first way described in Paragraph 44 herein). In this embodiment, the containers are provided with one stacked atop the other, making removal quick and easy for the consumer. The portion of the machine depicted has some similarities with that shown in FIGS. 14A-14C.

In FIG. 16A, an oven (e.g., microwave) is shown comprising an oven chamber 320 and an oven floor 322, which can move vertically. In FIG. 16A, floor 322 is in a lower position but when raise forms a closed vessel in combination with chamber 320. Also shown in FIG. 16A is container 324 with food to be heated 326 inside of it. Below the oven chamber is upper pusher 328 and lower pusher 330, both shown in a retracted position so as not to interfere with motion of floor 322. Opposite the pushers is access door 332 shown in the figure in closed position. Also, in FIG. 16A is a delivery shelf 334 having an optional stop or lip 336 in some embodiment variations. The shelf may be inside a delivery compartment or in some embodiment variations, exposed.

In FIG. 16B, floor 322 has been raised and container 324 is being heated. In FIG. 16C, the floor has descended to a lower position with meal 326. In FIG. 16D, lower pusher 330 has advanced and pushed container 324 onto shelf 334, e.g., until it contacts stop 336. In FIG. 16E, lower pusher 330 has retracted, second container 338 has been loaded onto floor 322 which has risen such that its upper surface is approximately flush or slightly above the upper surface of container 324. Container 338 may be loaded onto the floor just after fetching it from storage, or if some heating is required, it may have been heated after raising floor 322 to contact vessel 320. Between the lid of container 324 and the front edge of floor 322 is a small gap 340. In FIG. 16F, second container 338 is being pushed by upper pusher 328 in direction 342, allowing it to cross gap 340. During this time, container 324 is restrained from moving forward due to friction with container 338 by virtue of stop 336 in embodiment variations which include a stop. If container 324 is relatively heavy compared with container 338, stop 336 may be superfluous.

In FIG. 16G, the upper pusher 328 has fully moved container 328 so it is stacked on top of container 324, and then retracted. At this time, in some embodiment variations, a band may be applied to both containers to secure them together, using means known to the art of banding machines. In FIG. 16H, access door 332 has opened, affording simultaneous access to the two containers; the consumer has started to remove the containers as shown by arrow 344 after lifting them slightly to clear the stop. In some embodiment variations, stop 336 may be retracted so such lifting is not required. In some embodiment variations, after retracting stop 336 (if used), both containers may be pushed further toward the consumer to facilitate removal from the machine.

In some embodiment variations, no door 332 is provided and shelf 334 is accessible to the consumer. As such, the consumer may choose to remove the first container 324 before container 338 can be stacked on it. The machine controller can detect that removal, however, and as a result will not raise floor 322 as high as it would otherwise (FIG. 16E), instead pushing the second container with pusher 330 onto shelf 334 as in FIG. 16D, just like it did with the first container.

In some embodiments, the stacking of one container atop another is performed on floor 322 in lieu of shelf 334. For example, the first container may be heated and lowered, and then the second (unheated) container arranged on top of it; this may be facilitated by lowering floor 322 below the lower position shown in the figures, and a stop may be provided on floor 322. Movement of the second container from its (e.g., refrigerated) storage to a secure position above the first container, without excessive tilting or risk of falling, may require that a supplementary support for the second container be provided.

In some embodiments, the process of FIGS. 16A-16H can be modified so that it is the lower container that is unheated.

FIGS. 17A-17F also depict in cross-sectional elevation view a process used in some embodiments for dispensing two containers in a vending machine in which both containers are provided to the consumer at the same time and same location (the first way described in Paragraph 44 herein). In this embodiment, the containers are provided with one stacked atop the other, making removal quick and easy for the consumer.

In FIG. 17A, a first container 346 is shown on the floor 348 of an oven. A pusher 350 is provided, shown here in retracted position. An elevator stage 352 is provide as well as a transition surface 349 between floor 348 and elevator 352. In some embodiment variations (including the variation shown), the stage moves passively up and down due to the weight of a container loaded onto it. In other embodiment variations, the stage is driven up and down by an actuator. As shown, passive stage 352 is supported by compliant elements such as springs or symmetric flexures 354. The support design preferably allows vertical motion of the stage but no tilting. Not shown but present in some embodiment variations is a door that prevents premature access to the containers. However, should a consumer remove the first container before the second can be stacked, this is generally not a problem. However, if the stage returns passively to its upper position, enough time should be allowed for it to reach that position before the second container is pushed onto the stage. If the stage is returned actively by an actuator, this can be accomplished quickly after sensing that the first package has already been removed.

In FIG. 17B, first container 346 has been pushed by pusher 350 onto the stage, which is shown locked in its upper position by a lock (not shown) used in some embodiment variations. In other embodiment variations no lock is provided, and in other embodiment variations, the descent of the stage is damped (e.g., by a fluidic element), allowing time for the stage to be loaded before it descends. In FIG. 17C, the lock has been released and the stage has descended while flexures 354 are deformed, coming to rest against stop 356. Meanwhile, pusher 350 has retracted. At this time, the top of the lid of container 346 is no higher and (as shown), possibly slightly lower (indicated by numeral 355) than surface 349. In FIG. 17D, second container 358 has been loaded onto floor 348. In FIG. 17E, pusher 350 has pushed container 358 atop container 346. Finally, in FIG. 17F, pusher 350 has retracted and the consumer is removes both containers by moving them in the direction of arrow 360. While removing the containers, the motion of stage 352 is preferably constrained, or at least slowed (e.g., via fluidic damping as previously mentioned). In embodiment variations comprising an actuator for stage 352, the stage may be lifted by the actuator prior to removal of the containers by the consumer.

In some embodiments, in lieu of a container of food being heated from a cold or frozen state before serving, accompanying another container whose contents may be served cold, the vending machine may keep such containers in hot holding cabinets and dispense them along with containers from refrigerated cabinets. In such embodiments, many of the considerations, machinery, and processes described herein are nonetheless applicable.

In some embodiments, in lieu of or in addition to microwave radiation generated typically by magnetrons, RF heating with solid state energy generation (e.g., using NXP Semiconductor's products) can be used to localize RF energy into a smaller volume.

In some embodiments, a container provided to the consumer cold (or slightly heated) can also accommodate other items than a second meal component such as cutlery, napkins, a dessert, a mint, a discount coupon, etc.

Many of the considerations, machinery, and processes described herein may also be applied to vending of meals in which the entire meal is contained in one container, but another container is also dispensed with other items (edible items such as a side dish, a dessert, a drink) or otherwise.

In some embodiments, a vending machine with two microwave ovens may be used. One of these can be used for heating a first container, while the other is used to heat a second container (if heating is needed) or simply as a pass-through such that the food component in that second container can be made accessible (e.g., at the same time, as in the third ‘way’ of Paragraph 44) through the access port associated with the second oven. Also, having two ovens offers redundancy: should one oven fail, the controller can adapt such that a container intended for heating in the failed oven can instead be heated in the remaining functional oven.

### Controller

The control of the apparatus and the implementation of the methods and steps described herein may be achieved using hardware, software, or any combination thereof, together forming a controller or control system. The term “hardware” may refer to either one or more general or special purpose computers; microcontrollers; microprocessors; programmable logic controllers (PLCs); programmable automation controllers (PACs); embedded controllers; or other types of processor, any of which may be provided with a memory capability such as static or dynamic RAM (random access memory); non-volatile memory such as ROM (read only memory); EPROM (erasable programmable read only memory), or flash memory; magnetic memory such as a hard drive; optical storage media such as CD (compact disc) or DVD (digital versatile disc); etc. The term may also refer to a PAL (programmable array logic) device, an ASIC (application specific integrated circuit), an FPGA (field programmable gate array), or to any device capable of processing and manipulating electronic signals.

The term “software” may refer to a program held in memory, loaded from a mass storage device, firmware, and so forth. The program may be created using a programming or scripting language such as C, C#, C++, Java, Python, PHP, JavaScript, LabVIEW, MATLAB, or any other programming or scripting language, including structured, procedural, and object oriented programming languages; assembly language; hardware description language; and machine language, some of which may be compiled or interpreted and use in conjunction with said hardware. The control system may serve to load files, perform calculations, output files, control actuators such as motors, voice coils, solenoids, fans, and heaters, and acquire data from sensors, to automate or semi-automate apparatus which can implement the methods and steps described herein. Each method described herein, including any sequential steps that may be taken for the method's implementation and any modification of the behavior of the apparatus or control system as a result of human or sensor input, as well as combinations of such methods, may be implemented and performed by the control system, executing a program, or code, embodied in the control system. In some embodiments, multiple control systems may be employed, and portions of the functionality of the control system may be distributed across multiple pieces of hardware and/or software, or combined into a single piece of hardware running a single piece of software.

### Terminology

The term “ingredient” or “ingredients” refers to one or more distinct, edible food items used in the preparation of an item to be consumed, and the term “food product” or “food products” refers to one or more edible food items ready to be consumed. The singular and plural forms of both phrases may be considered interchangeable, and the phrases themselves may not always be strictly applied herein and may be considered at least in some situations to be interchangeable.

The term “component” generally refers to a portion of a meal that by itself does not constitute an entire meal and generally, a meal is assumed to comprise at least two components. Each component may further comprise a single ingredient or a combination of ingredients.

The term “meal” generally refers to one or more food items delivered for consumption, possibly involving processing of various kinds, and can include snacks and beverages.

“Proximate” or “in proximity to” generally refers to close enough to achieve the required functional purpose, for example, in the context of a dispenser or dispensing system, it refers to a distance comparable to a dimension of a typical pouch and more preferably within a smaller distance.

As used herein, words of approximation such as, without limitation, “about”, “substantial” or “substantially” refers to a condition that when so modified is understood to not necessarily be absolute or perfect but would be considered close enough to those of ordinary skill in the art to warrant designating the condition as being present. The extent to which the description may vary will depend on how great a change can be instituted and still have one of ordinary skilled in the art recognize the modified feature as still having the required characteristics and capabilities of the unmodified feature.

### GENERAL

Figures within this application are not necessarily to scale.

Motions are considered relative. Thus, if object A moves relative to object B which is at rest, the equivalent effect of object B moving relative to object A which is at rest is also contemplated in the disclosure.

It will be understood that particular embodiments described herein are shown by way of illustration and not as limitations of the disclosure. The principal features of this disclosure can be employed in various embodiments without departing from the scope of the disclosure. Those skilled in the art will recognize, or be able to ascertain using no more than routine experimentation, numerous equivalents to the specific procedures described herein. Such equivalents are considered to be within the scope of this disclosure and are covered by the claims.

It is intended that the aspects of the invention set forth herein represent independent invention descriptions which Applicant contemplates as full and complete invention descriptions that Applicant believes may be set forth as independent claims without need of importing additional limitations or elements, from other embodiments or aspects set forth herein, for interpretation or clarification other than when explicitly set forth in such independent claims once written. It is also understood that any variations of the aspects set forth herein represent individual and separate features that may form separate independent claims, be individually added to independent claims, or added as dependent claims to further define an invention being claimed by those respective dependent claims should they be written.

In view of the teachings herein, many further embodiments, alternatives in design and uses of the embodiments of the instant invention will be apparent to those of skill in the art. As such, it is not intended that the invention be limited to the particular illustrative embodiments, alternatives, and uses described above but instead that it be solely limited by the claims presented hereafter.

1: A method for dispensing a meal from a self-service vending machine, the method comprising:
(a) receiving, via a user interface, a consumer selection of a first meal component;
(b) receiving, via a user interface, a consumer selection of a second meal component or automatically determining a selection associated with the first meal component;
(c) receiving a single payment for a meal comprising the first meal component and the second meal component; and
(d) in response to receiving the single payment, controlling the vending machine to dispense the first meal component and dispense the second meal component.

2: The process of claim 1 wherein each of the two meal components is dispensed in a different temperature range than the other.

3: The process of claim 1 wherein the consumer selects a first component among multiple options and in response the machine controller automatically selects a pre-determined second component without additional action by the consumer.

4: The process of claim 1 wherein the consumer selects a first component among multiple options and in response the machine controller automatically presents multiple pre-determined options for the second component and requires that the consumer select the second component.

5: The process of claim 1 wherein the consumer selects a first component among multiple options and in response the machine controller automatically presents multiple pre-determined options for the second component, a recommendation for the second component, and requires that the consumer select the second component.

6: The process of claim 1 wherein the two components are dispensed in a single container.

7: The process of claim 1 wherein each of the two components is dispensed in its own container.

8: The process of claim 1 wherein one of the two components comprises at least one topping for the other component.

9: The process of claim 1 wherein at least one container is provided to hold the two components, components can be heated within the at least one container through exposure to RF energy, RF energy emitted from a small radiating aperture is applied to the at least one container, and one component is at least partially isolated from the RF energy through attenuation by an RF shield.

10: The process of claim 9 wherein the shield is selected from the group consisting of a water-based gel, a microwave susceptor, a water-based gel and insulator, and a microwave susceptor and insulator.

11: The process of claim 9 wherein the shield is separated from the at least partially isolated component by a thermal insulator.

12: The process of claim 7 wherein the containers are dispensed into a single delivery compartment or onto at least one shelf.

13: The process of claim 12 further comprising providing a delivery compartment or shelf and wherein the vending machine dispenses the first container into the delivery compartment and thereafter dispenses the second container into the delivery compartment such that the second container is stacked on top of the first container.

14: The process of claim 7 wherein both containers are made accessible to the consumer at the same time.

15: The process of claim 7 wherein a first container is dispensed after which a second container is dispensed.

16: The process of claim 15 comprising:
(a) detecting an obstruction condition due to the first container that prevents dispensing of the second container;
(b) withholding dispensing of the second container while the obstruction condition persists; and
(c) dispensing the second container after the obstruction condition is cleared.

17: The process of claim 15 wherein the machine controller notifies the consumer to remove the first container at a first time and notifies the consumer to remove the second container at a second time.

18: The process of claim 1 wherein at least one first component is available and selectable by the consumer and wherein the second component is not made selectable unless and until the first component is selected.

19: The process of claim 1 wherein a given first component is rendered unavailable for ordering by the machine controller because no suitable associated second component is currently available.

20: A user interface for a vending machine that dispenses a first and a second meal component in response to a single transaction, the user interface comprising:
(a) a display device;
(b) a machine controller;
(c) graphical elements indicating available first meal components;
(d) graphical elements indicating available second meal components;
(e) means for user selection of the first meal component; and
(f) means for user selection of the second meal component.

21: A process for automatically dispensing a first and second item from a self-service vending machine equipped with a machine controller wherein the selection of the first item restricts the selection of the second item.

22: The process of claim 21 wherein the selection of the second item is restricted by the machine controller to a single available item.

23: The process of claim 21 wherein the selection of the second item is restricted by the machine controller to a subset of available items.
